(19) United States
(12) Patent Application Publication
(10) Pub. No.: US 2012/0029912 A1
(43) Pub. Date: Feb. 2, 2012

(54) Hands-free Active Noise Canceling Device

(75) Inventor: Irving Almagro, Irvine, CA (US)

(73) Assignee: VOICE MUFFLER CORPORATION, Irvine, CA (US)

(21) Appl. No.: 12/844,776

(22) Filed: Jul. 27, 2010

(51) Int. Cl. G10L 21/02; H04R 3/00

(52) U.S. Cl. 704/226; 381/122

(57) ABSTRACT

An invention for eliminating the noise generated by a user speaking into a microphonic instrument is disclosed herein. In a first embodiment, the invention comprises a soundproofed housing arranged to cover a user's mouth region and a loudspeaker that outputs a processed sound wave having a phase that is opposite of the user's voice thereby canceling out the user's voice that was confined inside the housing. In a second embodiment, the invention comprises a soundproofed housing arranged to enclose a user's mouth area, a microphone to capture the user's speech, and a loudspeaker that outputs a processed sound wave having a phase that is opposite of the user's voice thereby canceling out the user's voice that was confined inside the housing.

### FIELD OF THE INVENTION

The present invention generally relates to hands-free active noise-canceling wireless devices and, in particular, to a compact device that covers a user's mouth area comprising a loudspeaker that cancels out his voice. The device is generally used in association with a microphone located close to the user's larynx to capture his voice for processing.

### BACKGROUND OF THE INVENTION

Ambient noise or vocal noise is the undesirable soundwave emitted when a person speaks. The reporting device that was patented over 20 years ago in U.S. Pat. No. 4,129,754 Gore, and U.S. Pat. No. 3,114,802 Beguin, provided viable solutions in canceling undesirable sounds or noise when using a microphone in ruckus adverse environments such as courtrooms. These voice muffled devices have been found to be excellent devices for speech recognition systems due to its microphone being positioned at a constant distance from the speaker's mouth (essential in achieving a high rate of recognition success) and its superb capability at reducing signal distortion. However, since the effectiveness of the device necessitated that it be pressed firmly against a user's face, such effortful and awkward manipulation caused people to shun the device for other uses, e.g., as a cellphone noise-suppression accessory.

The Active Acoustic Attenuator that was patented over 20 years ago in U.S. Pat. No. 2,043,416 Lueg, provided a viable solution for active noise cancelation by using a microphone, amplifier and loudspeaker components to reduce undesirable sounds by feeding back a 180 degree phased signal of the original sounds. Prior arts such as in U.S. Pat. No. 4,473,906 Warnaka et al, and U.S. Pat. No. 4,455,675 Bose, et al, made substantial improvements on the Lueg patent, such as speed and flexibility of the sound-canceling process but these devices were essentially for the reduction of ambient noise to be heard by the user, or basically for headphones and earphones. However, these apparatuses do not reduce the vocal noise generated by a user speaking into a microphone. They only cancel the noise that reaches the user's ears. The prior art such as in U.S. Pat. No. 6,690,800 Resnick, provided an improved solution to the vocal noise in the immediate vicinity of a microphone talker but since the invention does not enclose the speaker's voice a substantial noise becomes scattered in the vicinity. Further, the inclusion of the signal processing circuitry would make the invention too bulky and would not be suitable for use as a mouthpiece, based on current state-of-the-art technology.

Thus, enclosing a loudspeaker inside a small housing that covers a speaker's mouth area and having the active noise canceling electronics located at a suitable distance away from that housing, such arrangement would allow a voice silencing device to be compact and convenient to use. A microphone that would provide the anti-noise signal can be located outside the device to eliminate undesirable echo that results when both a microphone and a loudspeaker are co-located inside an enclosure. An example of such a microphone is the throat microphone that can capture the user's voice from his throat area. This arrangement also allows the anti-noise electronics a few milliseconds of extra time to process the captured voice signal so that the output of the loudspeaker is 180 degrees out-of-phase with the user's voice as it comes out of his mouth.

### SUMMARY OF THE INVENTION

In an exemplary embodiment, the present invention, comprises a soundproofed housing generally conforming to a user's mouth area further comprising a loudspeaker for outputting an anti-noise soundwave generated by a sound processing circuit to cancel out the user's voice. The device is generally associated with a microphone that is located close to the user's larynx to capture the user's voice to produce the anti-noise signal and the input for the wireless transmitter, and a sound processing circuitry located at a suitable proximity from the housing.

The invention may further be fixed onto a pivot mechanism and joined at the microphone end of an over-the-head headset boom such that when the invention is swung inwardly it will cover the user's mouth area thereby confining the user's voice inside the housing. After the user has finished speaking, he can then swing the invention outward to uncover his mouth thereby allowing his voice to be heard.

Alternatively, the invention may also be affixed onto a pivot mechanism with or without a support arm and mounted on a helmet's chin cup such that when the invention is swung upwardly it will cover the user's mouth area thereby confining the vocal noise inside the housing. After the user has finished speaking, he can then swing the invention downward to uncover his mouth thereby allowing his voice to be heard.

It is therefore an object of the invention to provide an active noise canceling mouth apparatus that can be attached to a headband assembly.

A further object of the invention is to provide an active noise canceling mouth apparatus that can be mounted onto a helmet's chin cup.

A further object of the invention is to provide an active noise canceling mouth apparatus with a vent to reduce pressure build-up inside the device when the user speaks while the device is covering his mouth.

A further object of the invention is to provide an active noise canceling mouth apparatus whereby the microphone to capture a user's voice is a throat, bone, or similar type.

A further object of the invention is to provide an active noise canceling mouth apparatus that can be attached to a handle for handheld use.

A further object of the invention is to provide an active noise canceling mouth apparatus having a quick disconnect adapter or connector to readily link or unlink said device to a sound processing circuit.

A further object of the invention is to provide an active noise canceling mouth apparatus that can incorporate a removable sound absorbing interior housing, liner, or baffle component.

A further object of the invention is to provide an active noise canceling mouth apparatus that can contain germicidal, antibacterial, or odor suppressing materials.

A further object of the invention is to provide an active noise canceling mouth apparatus that can easily be cleaned and sanitized.

### BRIEF DESCRIPTION OF THE DRAWINGS

FIG. 1 is a pictorial representation of the front side of an embodiment of the invention.

FIG. 2 is a pictorial representation of the rear side of an embodiment of the invention.

FIG. 3 is a front elevational view of an embodiment of the invention with a protective cover of the loudspeaker.

FIG. 4 is a front elevational view of an embodiment of the invention showing the internal loudspeaker after the protective material has been removed.

FIG. 5 is a side elevational view of an embodiment of the invention.

FIG. 6 is a sectional view taken along line B-B in FIG. 7.

FIG. 7 is a top view of an embodiment of the invention.

FIG. 8 is a sectional view taken along line A-A in FIG. 3.

FIG. 9 is a pictorial representation of an embodiment of the invention shown with a language translation adapter assembly.

FIG. 10 is a pictorial representation of an embodiment of the invention shown with two jacks on the rear side to accept an adapter assembly.

FIG. 11 is a pictorial representation of a language translation adapter assembly.

FIG. 12 is a pictorial representation of the rear side of a language translation adapter assembly shown with two plugs.

FIG. 13 is a top sectional view taken along line C-C in FIG. 9.

FIG. 14 is a side sectional view taken along line D-D in FIG. 9.

FIG. 15 is a pictorial representation of a helmet embodiment of the invention showing a chin cup assembly and a mouthpiece assembly.

FIG. 16 is a rear elevational view of a chin cup assembly of a helmet embodiment of the invention shown with guide tracks and securing holes for accepting a support member.

FIG. 17 is a top plan view of a chin cup assembly for a helmet embodiment of the invention.

FIG. 18 is a sectional view taken along line E-E in FIG. 16.

FIG. 19 is a rear elevational view of another embodiment of the invention showing a chin cup assembly with a connector assembly, a video camera and an external microphone.

FIG. 20 is a front elevational view of a mouthpiece assembly for a helmet embodiment of the invention, shown with a support member.

FIG. 21 is a side elevational view of a mouthpiece assembly for a helmet embodiment of the invention, shown with a support member.

FIG. 22 is a bottom view of a mouthpiece assembly for a helmet embodiment of the invention, shown with a support member.

FIG. 23 is a pictorial representation of a typical transceiver assembly for a helmet embodiment of the invention.

FIG. 24 is a pictorial representation of a helmeted soldier using the invention in an active noise cancellation mode.

FIG. 25 is a pictorial representation of a helmeted soldier with the invention in an inactive mode.

FIG. 26 is a pictorial representation of a helmeted soldier using a language translation embodiment of the invention.

FIG. 27 is pictorial representation showing a helmeted soldier speaking to a foreigner in accordance with a language translation embodiment of the invention.

FIG. 28 is pictorial representation showing a foreigner speaking to a helmeted soldier in accordance with a language translation embodiment of the invention.

FIG. 29 is pictorial representation showing a helmeted soldier speaking to a fellow soldier in accordance with a language translation embodiment of the invention.

FIG. 30 is a pictorial representation of a headset embodiment of the invention.

FIG. 31 is a pictorial representation of a user using a headset embodiment of the invention.

FIG. 32 is a front view of a user using a headset embodiment of the invention whereby the mouthpiece assembly is seen in a closed position.

FIG. 33 is a front view of a user not using a headset embodiment of the invention whereby the mouthpiece assembly is seen in an open position.

FIG. 34 is a side view of a user using a headset embodiment of the invention whereby the mouthpiece assembly is seen in a closed position.

FIG. 35 is a side view of a user using a headset embodiment of the invention whereby the mouthpiece assembly is seen in an open position.

FIG. 36 is a pictorial representation of a user using a language translation component of a headset embodiment of the invention.

FIG. 37 is a pictorial representation showing a user speaking to a foreigner in accordance with an embodiment of the invention.

FIG. 38 is a pictorial representation showing a foreigner speaking to a user in accordance with an embodiment of the invention.

FIG. 39 is a pictorial representation showing a user speaking to a fellow native speaker in accordance with an embodiment of the invention.

FIG. 40 is a flowchart diagram summarizing an active noise cancelling process in accordance with an embodiment of the invention.

FIG. 41 is a flowchart diagram summarizing a speech-to-speech language translation process in accordance with a language translation embodiment of the invention.

FIG. 42 is a diagram of a typical operational mode of the device in accordance with a helmet embodiment of the invention showing typical short range communication links.

FIG. 43 is a diagram of a typical operational mode of the device in accordance with a helmet embodiment of the invention showing some short and long range communication links.

FIG. 44 is a diagram of a typical operational mode of the device in accordance with a headset embodiment of the invention showing typical short range communication links.

FIG. 45 is a diagram of a typical operational mode of the device in accordance with a headset embodiment of the invention showing some short and long range communication links.

FIG. 46 is a pictorial representation of an embodiment of the invention showing the position of the invention in relation to a typical user when the device is being used.

### DETAILED DESCRIPTION OF THE PREFERRED EMBODIMENT

As used herein, the term “user,” is intended but not limited, to generally refer to a person who is operating or manipulating or holding or grasping, or speaking to, or a combination thereof, a microphonic device having a purpose of effecting a translation of his or her speech to an intended language. Generally, the user is someone who wears a helmet, or someone who wears a headband or headset type apparatus, or someone using a gadget that can accommodate a mouthpiece, or a combination thereof.

As used herein, the term “foreigner,” is intended but not limited, to generally refer to someone who speaks a language that is different from the native language of a user of the invention. A foreigner may also be a person who is not operating, nor manipulating, nor holding, nor grasping, nor using, nor a combination thereof, a device of a user.

As used herein, the term “interpreter,” or “language interpreter,” is intended but not limited, to generally refer to a person or a machine that is able to understand and vocalize a foreign language. Further, an interpreter may be a person who is not operating, nor manipulating, nor holding, nor grasping, nor using, nor a combination thereof, a user's device.

As used herein, the term “housing” is intended but not limited, to generally refer to a component such as a protective cover, casing, case, shell or enclosure designed to contain, enclose or support mechanical, electrical, electronic components, or a combination thereof. It can be homogeneous, heterogeneous, multi-layered, multi-bodied, multi-frame, multi-colored or any combination thereof. It may be rigid, semi-rigid, flexible, supple, or a combination thereof. It may also have properties such as sound absorption, soundproofing, sound muffling, noise canceling, sound blocking, sound baffling, sound distorting, anti-bacterial, germicidal, anti-viral, anti-odor, electromagnetic shielding, radiation shielding, or a combination thereof. The function of the housing includes confining or suppressing sound and may further include an additional housing.

As used herein, the term “translator,” or “Personal Translator,” or “remote translator,” is intended but not limited, to generally refer to a human interpreter, a software program, a machine or hardware interpreter, or a similar instrument that converts a user's native language into another native or foreign language. The translator can be located on a user's body or at a remote location. It may have a transceiver, an amplifier, a sound processor, or a combination thereof.

As used herein, the term “processor,” or “sound processor,” or “speech processor,” or “voice processor,” is intended but not limited, to generally refer to an audio system having a hardware and software components such as a computer, application processor, memory, sound quality optimizer, transceiver, translator, power supply, battery, battery charger, timer, test and monitoring circuitry, amplifier, video circuit, digital and analog processors, AF or RF signal conditioners, automatic volume or gain control circuitry, active noise cancelation electronics, other associated mechanical, electronic and electrical components, or a combination thereof. Further, the function of the processor includes: converting voice signals into anti-noise signals; transmitting voice signals to a remote receiver; or receiving RF analog and/or digital signals; or translating languages; or a combination thereof. The transmission and reception mode of a transceiver can also be simplex, half-duplex or multiplex.

As used herein, the term “battery”, or “battery pack”, is intended but not limited, to generally refer to a direct-current voltage source made up of one or more units that convert chemical, thermal, nuclear, mechanical or solar energy into electrical energy. It can be disposable, rechargeable type and/or a combination thereof. A power source such as an AC adapter can also be referred to as battery. It is understood that the battery technology is constantly evolving and improving, therefore the type or kind of battery that the present invention may adopt will depend on the preference of an application or manufacturer.

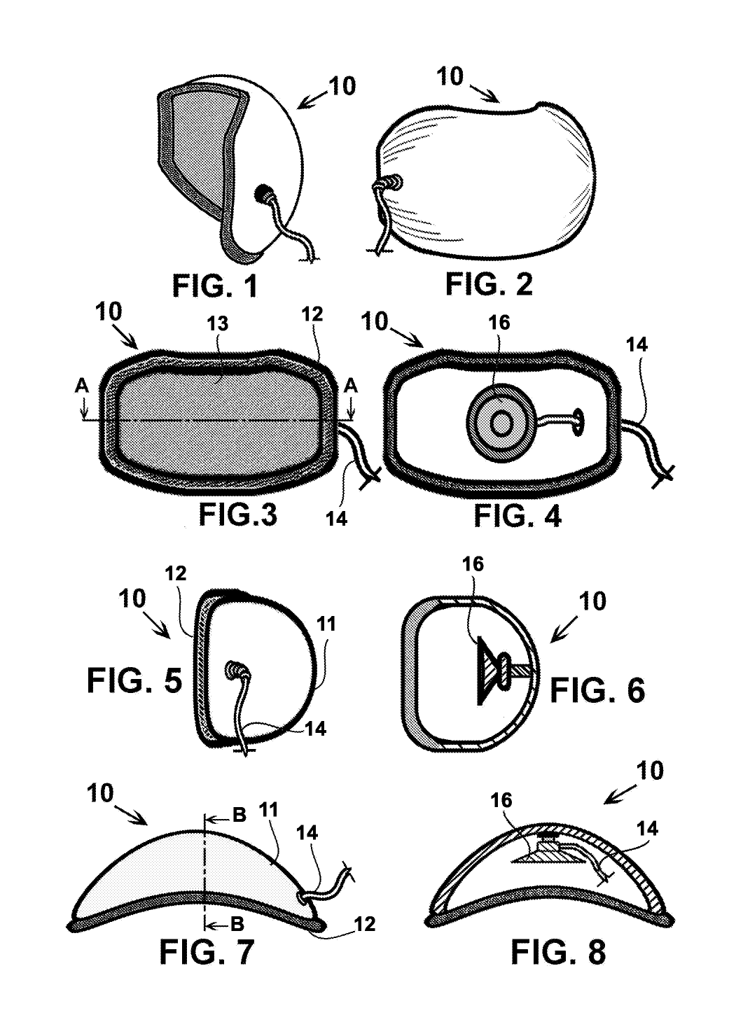

FIGS. 1-8 are views of the present invention, seen as general reference 10, comprising a housing 11 having a generally concave shape conforming to the contour of a user's mouth area whereby the housing 11 further comprises: a loudspeaker 16 that produces an anti-noise soundwave to cancel out the user's voice and a wiring harness 14 to connect the loudspeaker 16 to a sound processing system 40 located at a suitable proximity from the housing 11.

The cable 14 may be terminated by separate plugs or adapters that correspond to the receiving unit's jacks such as the ones used to connect to a typical PC's sound card. The invention 10 is similar in functionality to a peripheral device such as a PC printer that outputs data only, including sending status signals back to the PC. The housing 11 can have a protective foam or liner 13 to reduce the vocal noise emitted by a user speaking into the invention 10. A flexible absorbing material or cushion 12 affixed to the rim portion of said housing 11 may be implemented on said invention 10 to provide comfort to the user.

In order to minimize the echo that gets generated inside the housing 11, a microphone 90 is placed at a suitable location, generally on the exterior part of the housing 11, although an echo canceling and/or noise canceling type of microphone makes its emplacement inside the housing viable. The canceling microphone should be positioned at a suitable distance between a user's mouth and said housing 11 to take into account the incremental delay in the processing of the user's voice by the processor 40. The microphone 90 may be of the throat type, where it is generally positioned next to a user's larynx to capture the user's voice at the earliest stage of development to allow a processor 40 a few milliseconds time to process and output the desired inverted sound wave. A bone type may also be used instead of the throat type microphone. A wiring hole 14a is provided for cable 14 to pass the wires of the invention to a processor 40. To reduce unwanted pressure build-up inside the invention 10 during its operation, an air vent, preferably of the one-way type, may be located on or inside the housing 31. FIG. 3 shows the invention 10 with a protective foam cover 13 in place while FIG. 4 shows the invention 10 without it. A sensor may be implemented or incorporated inside the housing 11 to detect or monitor the status of invention 10. One or more internal microphone may also be implemented with the invention 10 by using a microphone that has echo and/or noise canceling characteristics positioned at a suitable distance between a user's mouth and said housing 11.

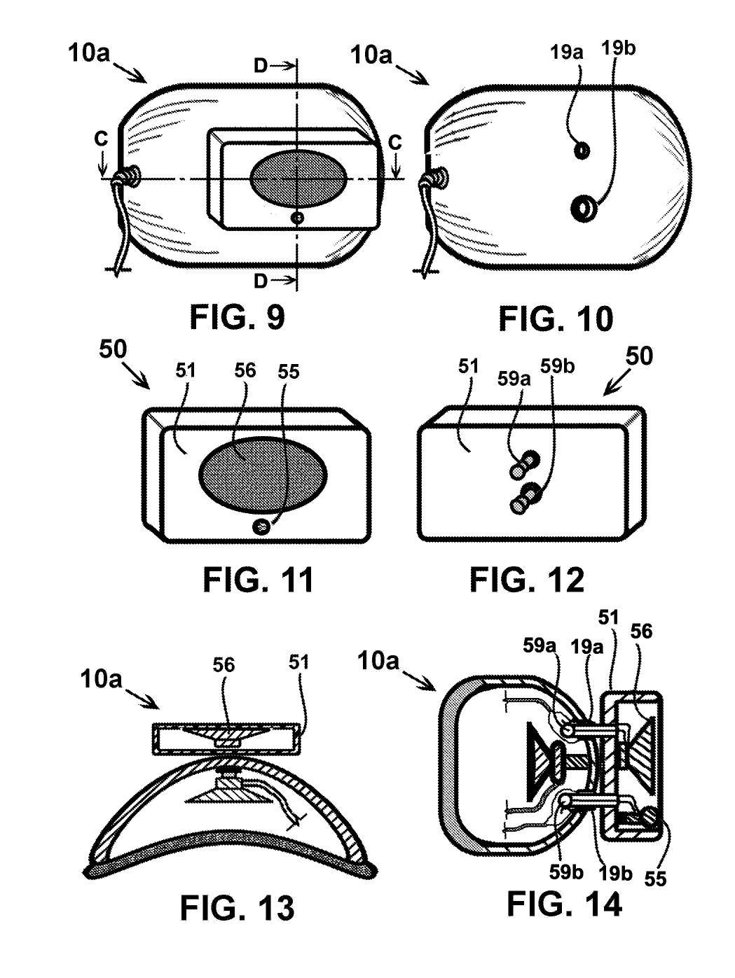

FIGS. 9-14 show a language translation embodiment of the invention 10a generally comprising the invention 10 having female jacks 19a/19b to accept an adapter and an attachable translator assembly 50. The assembly 50 generally comprises: a housing 51 which further comprises a microphone 55 directed towards a foreigner to capture said foreigner's speech, a loudspeaker 56 directed towards a foreigner for outputting the translated speech of a user; and connector plugs, male connectors, prongs or adapters 59a and 59b that correspond to the mouthpiece 30 jacks 19a/19b to provide electrical connections for the microphone 55 and loudspeaker 56.

The connectors may incorporate different sizes of plugs 59a/59b that correspond to the appropriate jacks 19a/19b. For example, the plug 59a can be made smaller than plug 596b to prevent the language accessory plugs from being incorrectly inserted into the mouthpiece's sockets. Further, said connectors may have provisions for additional components such as a video camera system to capture a foreigner's gestures or an ultrasonic distance detection system to allow for automatic volume control of loudspeaker 56 or other distance enhancement functions. The anti-noise loudspeaker 16 and anti-noise circuitry in the sound processor 40 may be disabled when the device 10a is used for language translation to reduce the battery drain or signal feedback issues.

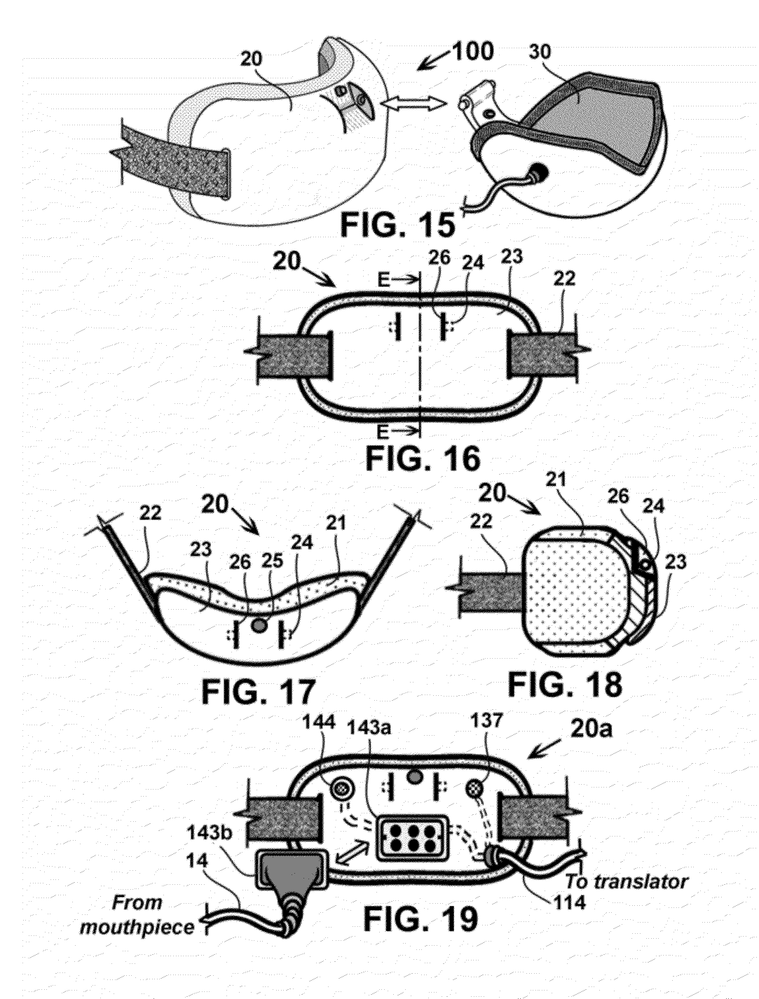

FIG. 15 shows a helmet embodiment of the present invention 10, seen as general reference 100, comprising mainly of a chin cup assembly 20 and mouthpiece assembly 30 whereby said chin cup 20 is the base that the mouthpiece 30 can be mounted onto. The mouthpiece assembly 30 is an embodiment of the invention 10 that is affixed to a rotatable arm support member and can be pressure fitted and mounted onto the chin cup assembly 20.

As shown in FIGS. 16-18, the chin cup assembly 20 is generally a retrofittable component and further comprises: a rigid housing or hard shell 23 having a contour shape conforming to a person's chin; a flexible impact absorbing material or cushion 21 affixed to the inner portion of said housing 23 to provide comfort to the user; a strap 22 that has the same material used to secure a helmet firmly on a user's head; and a securing hole 24 located on the exterior portion of the housing 23 to allow the mouthpiece arm support member 38 to rotate on its pivot member 33 while fully engaged and mounted onto the chin cup 20. A fastener, clasp, or latch 25 may be implemented to lock or hold the mouthpiece arm support member 38 in place when the device 10 is in use. Further, a magnetic or electromagnetic latch mechanism 25 may also be implemented for locking the chin cup 20 in place. A guide track 26 allows the positioning and stabilizing of the mouthpiece 30 to the securing hole 24 on chin cup assembly 20. The guide facilitates the mounting of the rotatable mouthpiece assembly 30 on the chin cup assembly 20.

FIG. 16 shows the front view of the chin cup assembly 20. The succeeding views demonstrate further the arrangements of the general components of the chin cup 20 starting with the top view (FIG. 17) and finally the side sectional view (FIG. 18).

FIG. 19 shows the front view of an enhanced embodiment of the chin cup assembly 20a generally comprising a chin cup housing 20, an external microphone 137 positioned or directed towards a foreigner to capture said foreigner's speech for translation into the user's language and to enhance the quality of said captured speech, a quick-disconnect adaptor 143a that corresponds to a plug 143b, and a video camera 144. Microphone 137 can also be implemented to capture a user's speech when the mouthpiece 30 is inactive or detached from the chin cup 20 allowing the user to continue to have telecommunications capabilities. Electrical conductors or contacts for the wires of said microphone 39 may be situated on the surfaces of securing holes 24 whereby said contacts correspond to conductors located on the surfaces of pivot members 33 that connect to electrical and electronic components on the invention 10. A quick-connect adaptor 143a that corresponds to plug 143b allows the facilitation of the connection or disconnection of the electrical and electronic components of said assembly 20a and the mouthpiece 30 to the language translation assembly 40. The wiring harness 114 connects the electrical/electronic components on the device to external units such as a transceiver or sound processor. The video camera 144 is generally positioned on the exterior of assembly 30 to capture a foreigner's gestures, thereby enhancing the device's capabilities. It is understood, however, that most soldiers that are currently in combat in Iraq already have such a component 144 as part of their gear and therefore in such embodiment the translation assembly 40 will have in place the necessary circuitry and software to complement the existing hardware.

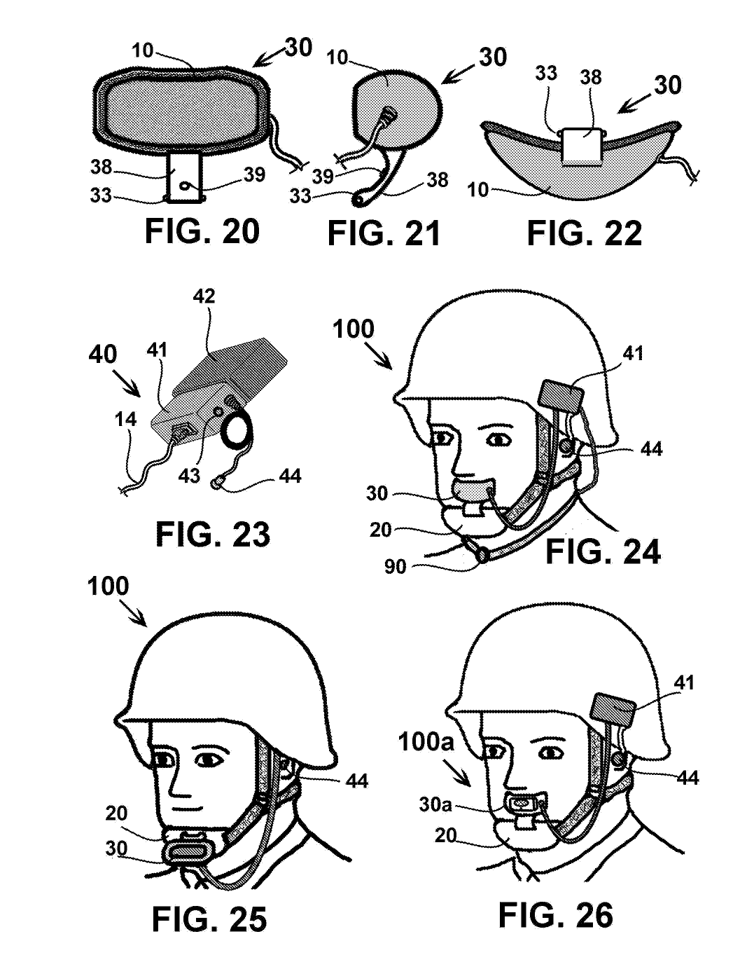

FIGS. 20-22 show a mouthpiece assembly 30 comprising the invention 10 and an arm support member 38 further comprising a pivot member 33 and a fastener, clasp, detent or latch mechanism 39 to hold the mouthpiece 30 in place when it is being used. The pivot 33 is associated with the securing hole 24 located on the chin cup 20 and allows for the mouthpiece 30 to swivel up or down while fully engaged and mounted onto said chin cup 20. To join or mount the mouthpiece 30 to the chin cup 20, the mouthpiece 30 is grasped and manipulated such that the pivots 33 align with their corresponding securing holes 24, pressure fitting the mouthpiece 30 onto chin cup 20. The pivotal axis defined by pins 33 allows the mouthpiece 30 to swivel up to cover the user's mouth area and swivel down to uncover the user's mouth area, depending on the desired application. To detach or disengage the mouthpiece 30 from the chin cup 20, the mouthpiece 30 is grasped and pulled outwardly, withdrawing the pins 33 from their corresponding securing holes 24, and pulling or moving the mouthpiece 30 completely away from the chin cup 20. A suitable vent may also be incorporated on the mouthpiece 30 to lessen the sound pressures that may build up inside.

The latch 39 is associated with the fastener 25 located on the chin cup 20. It may also incorporate or be incorporated with a pushbutton switch or a sensor component. The sensor can detect and perform functions such as causing the device 10 to get activated when it is in the closed or up position, and to deactive the invention 10 when in the open or down position. A photodiode sensor, proximity sensor, or distance detector located inside the mouthpiece 30 may be implemented instead of the sensor component. The sensor which detects the status of the invention 10, whether it is in-use or not, should be positioned in a suitable location on housing 31. The microphone 90 in conjunction with voice command or similar software can also be used as part of a control component for automatically adjusting the output or volume of the language loudspeaker 56, especially in situations where a foreigner is standing further away.

FIG. 23 shows a typical transceiver and/or sound processor assembly 40 that can be located at a suitable proximity from the invention 10. It generally comprises a transceiver 41, a battery 42, a microphone jack 43, an earphone 44, and wiring harness 14. The battery as well as the anti-noise processor may be integrated with the transceiver 41. The microphone jack is used to connect microphones such as a throat microphone 90, a bone microphone, or other similar microphones. The earphone 44 allows the user to hear the received signals such as audio, vocalized control commands, interpreted speeches, and other voice signals.

FIG. 24 shows an embodiment of the invention 100 being used by a helmeted person whereby the mouthpiece 30 is swiveled upwards and covering the user's mouth thereby muffling his speech by means of anti-noise intervention and passive voice muffling materials. An earpiece, earcup or earphone 44 connected to a transceiver or amplifier unit allows a user to hear received audio, feedback data, or other audio functionalities thereof

FIG. 25 shows the invention 100 not being used by a helmeted person whereby the mouthpiece 30 is swiveled downwards and not covering the user's mouth thereby allowing the user's voice not to be muffled or cancelled out. In this situation, the device 10 is either deactivated, on standby, or powered down and allows the user to converse or speak in a normal manner.

FIG. 26 shows an embodiment of the invention 100a comprising a chin cup 20 and mouthpiece assembly 30a being used by a helmeted person for language translation. The assembly 30a further comprises a mouthpiece 10a, a support 38, a pivot 33, and a latch 39. When the mouthpiece 30a is swiveled upwards relative to the chin cup 20, covering the user's mouth, some of the unwanted untranslated speech are kept from being heard by a foreigner by the soundproofing and/or active-noise-canceling properties of the device 10. The user's speech is captured by microphone 90 or external microphone 55 and gets translated by a translator 40 or remotely by a translation system 80. The loudspeaker 56, seen on the exterior of mouthpiece 30a, outputs the translated speech for a foreigner to hear. The exterior microphone 55 seen on the front of the mouthpiece 30a generally captures the speech of a foreigner whereby it is translated and the translation is outputted on the earphone 44 for a user to hear. Microphone 55 may also be used to capture the user's speech by the implementation of a tubing or similar medium of channeling the user's voice to the microphone 55. The translator 40 or a transceiver 41 can be mounted securely on a user's helmet or clothing or other parts of his body, either inside or outside, by Velcro tape, hooks, or other mechanical fasteners that would facilitate the detachment from the mouthpiece 30a.

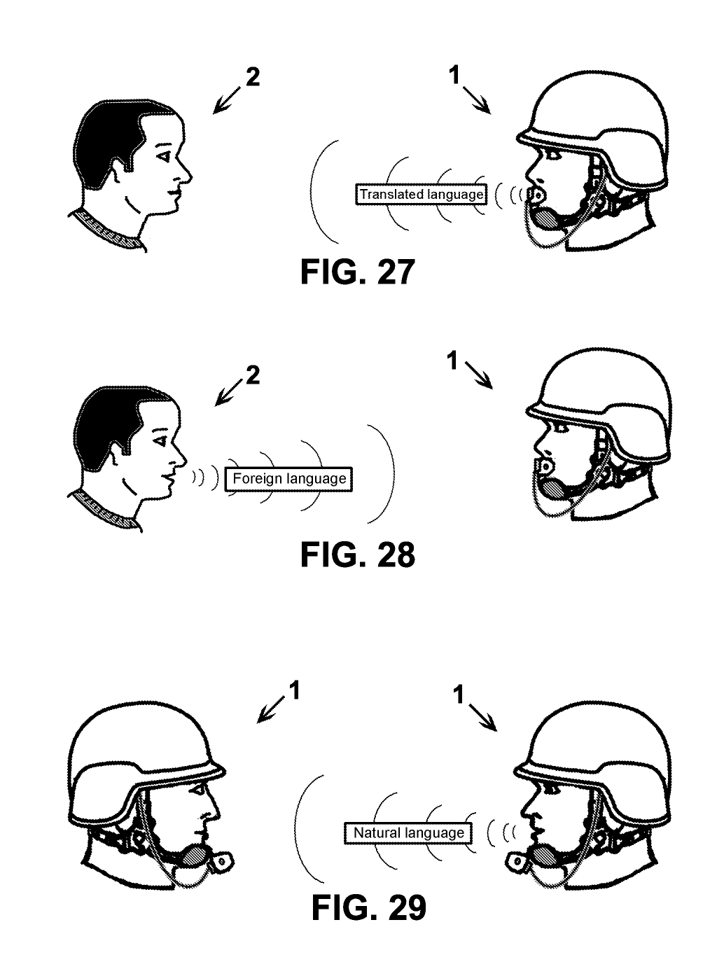

FIGS. 27-29 are pictorial representations describing a typical usage of the language embodiment of the invention 10 detailing further the explanations provided by the previous paragraphs between a user 1, a foreigner 2, and another user 1. In FIG. 27, the user 1 is seen translating his speech by speaking into the mouthpiece 10a that covers his mouth area preventing the foreigner 2 from hearing his untranslated speech or vocal noise wherefor subsequently said speech is translated by a translator. The translated speech is then amplified and consequently fed to the loudspeaker 56 producing a suitable output for a foreigner to hear.

In FIG. 28, the foreigner 2 is seen speaking into the external microphone 55 located on the exterior of the user's mouthpiece 30a whereby his untranslated speech gets sent to a translator system 40 (local) or 80 (remote). The translated speech of the foreigner 2 is then conditioned and subsequently fed to the earphone 44 producing a suitable output for the user 1 to hear.

In FIG. 29, the user 1 is seen speaking to another user 1 but this time his mouthpiece 30a is not covering his mouths thereby allowing his untranslated speech to be heard by the other user 1 who speaks with the same native language.

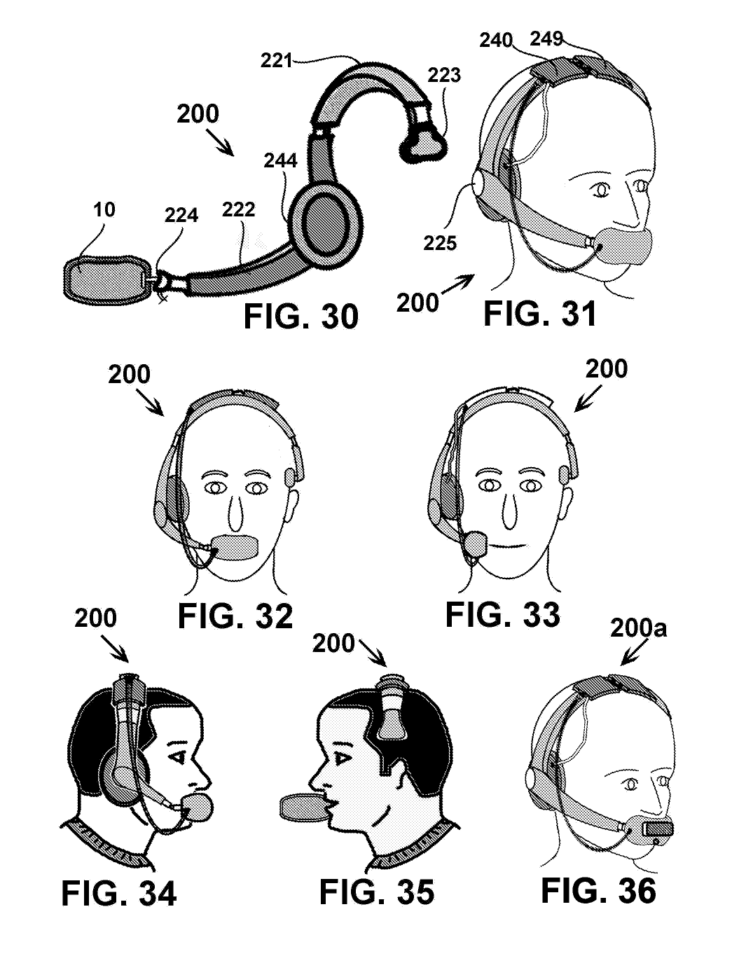

FIG. 30 shows a headset embodiment of the present invention, seen as general reference 200, comprising a mouthpiece assembly further comprising the invention 10 and a pivot mechanism 224, and a headband assembly further comprising an adjustable over-the-head arcuate component 221, a rotating boom component 222 having one end attached to the arcuate unit 221 by a pivot mechanism 225 and the other end having a socket (part of a ball-and-socket unit) or a pivot mechanism 224 that connects to the invention 10, and a temple pad portion 223 positioned at the other end of arcuate unit 221 to ensure that the headband assembly stays firmly on a user's head. Located on the opposite or interior side of the pivot member 225 is an earcup component 244 that allows a user to hear feedback or proofreading data or any audio or other audio functionalities thereof.

The pivot unit 224 allows the invention 10 to swivel and/or rotate generally sideways to cover a user's mouth area. A detent functionality of said mechanism 224 may be implemented to keep the invention 10 in place during operation and/or non-operation, preventing the invention assembly 10 from flopping about. Further, the other end of arcuate 221 may be terminated with a structure that can accommodate a second earcup component 244 in place of a temple pad 223. To use the headset embodiment 200 effectively, the invention 10 may be made to touch or press lightly against a user's face, covering much of the user's mouth area whereby it can confine or interfere with most of the user's voice.

FIG. 31 shows a pictorial representation of the headset 200 in a general adaptation. A sound processing assembly 240 such as a transceiver 41 or a translator 40/80 may be located on the top portion of the arcuate component 221. A battery pack or compatible power source 249 that is rechargeable, detachable, and/or replaceable can also be implemented for the headset 200 and mounted in proximity with the translator 240.

The main function of the sound processor assembly 240 is for noise reduction and is achieved by using prior art techniques such as utilizing microphone, amplifier, and loudspeaker components to reduce undesirable soundwaves by feeding back a 180 degree phased (anti-noise) signal of the original soundwaves and causing the signals to cancel each other out. A language translation functionality can be integrated with the sound processor 240.

FIGS. 32 and 34 are pictorial representations of a headset 200, shown with the mouthpiece 10 covering a user's mouth or in the closed position, causing his voice to be confined inside the housing while it is also being canceled out by the loudspeaker inside. A microphone 90 captures his voice and conveys it to the processor 240.

FIGS. 32 and 35 show pictorial front and side views of how device 200, shown with the mouthpiece 10 not covering a user's mouth or is in the open position, would look like when it is ‘not used’. In this open position, the device 10 is deactivated, powered down, or in standby mode, and therefore his voice will be heard by others when he speaks.

FIG. 36 is a perspective pictorial view of a headset language translation embodiment of the invention 10 generally referenced as device 200a being used for translating speech comprising of a headband assembly 200 and a translator mouthpiece 10a.

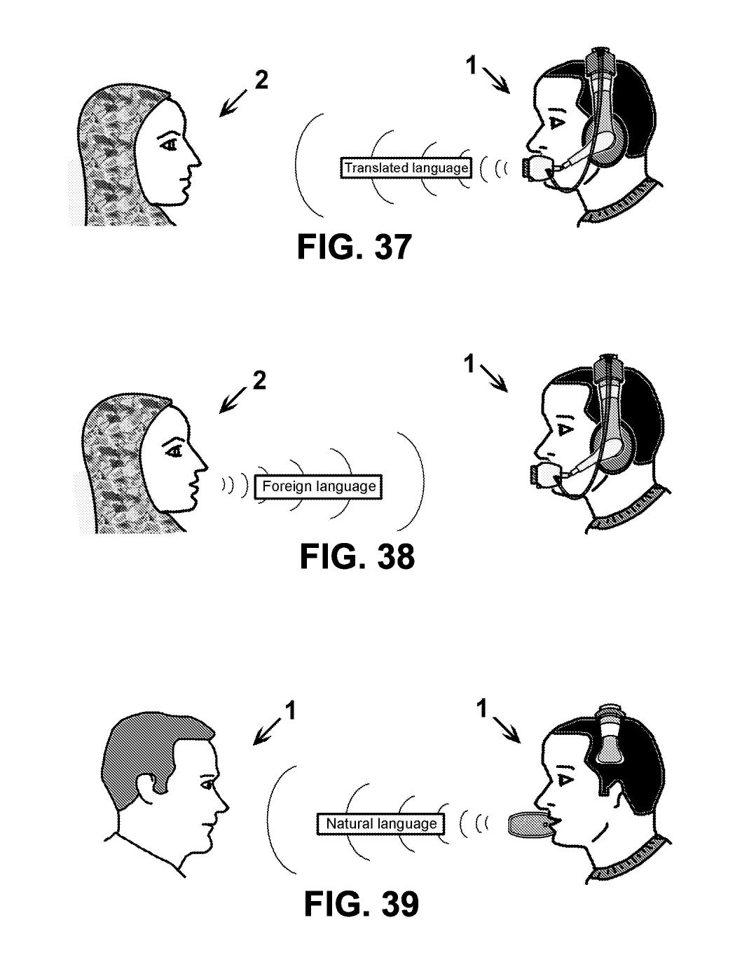

FIGS. 37-39 are pictorial representations illustrating in more detail the typical scenarios provided in the previous paragraph between a headset language translation user 1, a foreigner 2, and another user 1. In FIG. 37, the user 1 is seen translating his speech by speaking into the microphone 55 of the mouthpiece 10a that is covering his mouth preventing the foreigner 2 from hearing his untranslated speech. The translated speech is received and then processed where it is consequently fed to the loudspeaker 56 producing a suitable output for a foreigner to hear.

In FIG. 38, the foreigner 200 is seen speaking into the microphone 55 of the mouthpiece 10a whereby his untranslated speech gets sent to a translator 40/80. The translated speech of the foreigner 2 is then conditioned and consequently fed to the earphone 244 producing a suitable output for the user 1 to hear.

In FIG. 39, the user 1 can be seen speaking to another person 1 who speaks the same language and this time the mouthpiece 10 is not covering said user's mouth thereby allowing his untranslated speech to be heard by the other person 1 normally.

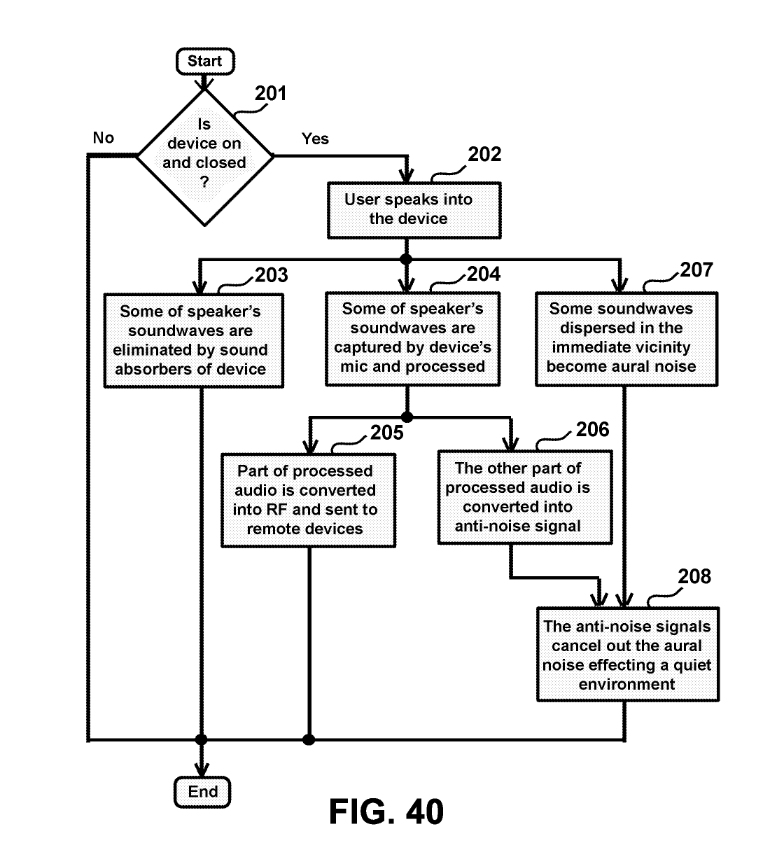

FIG. 40 shows a flowchart diagram of the anti-noise cancellation process of an embodiment of the invention 1 whereby the device 10 is first checked if it is in an in-use status (event 201). If it is, then the user operates the device 10 by speaking into the mouthpiece (event 202). His speech is however captured by the external microphone 90 and processed by a processor 40. If device 10 is not in on or in-use mode, then the process is ended. The soundwaves from the user's voice that are generated by such processes, for purposes of simplification, can be demonstrated as generally divided into 3 different pathways.

The first pathway points out that some of the soundwaves are eliminated by the sound absorbers 13 embedded in the mouthpiece 10 (event 203). Event 204 shows some of the soundwaves being captured by microphone 90 are processed and split into two signals, one signal is converted into radio waves and sent to remote sound processors by a transceiver (event 205), and the other signal is reverse phased to produce the output that loudspeaker 16 generates as the anti-noise wave (event 206). The third set of soundwaves, shown in event 207, are dispersed and confined inside the mouthpiece, becoming unwanted sound or referred to as vocal noise. Finally, in event 208, this vocal noise is interfered by the anti-noise wave generated in event 206 causing them to cancel each other out and become faint or inaudible.

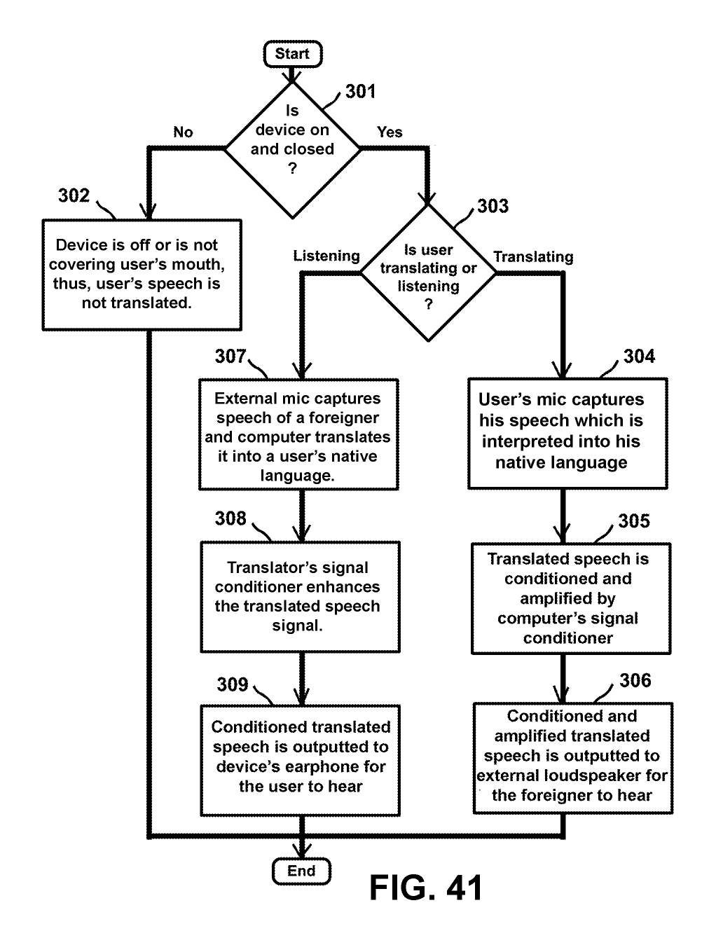

FIG. 41 shows a flowchart diagram of an embodiment of the invention 10 summarizing an integrated computerized system process for speech-to-speech language translation whereby the process starts by checking to see if user 1 is using the invention 10a, such as when the mouthpiece is swiveled inward covering a user's mouth area or closed (step 301). If the mouthpiece 10a is not being used, i.e., the mouthpiece 10a is in an open or swiveled outward arrangement, and is not powered up, then the process terminates (step 302). If the invention 10a is in a standby mode or powered up, then as soon as the mouthpiece 10a is closed (covering user's mouth), the microphone 90 will be primed to receive and process the speech of a user 100 (step 303). It should be noted that when the device 10a is in use, a translating mode (the speech of user 1 is being translated) and a listening mode (the speech of foreigner 2 is being translated) can happen simultaneously (step 303). It is preferred that the translation and listening processes do not happen simultaneously in order to achieve an effective dialogue between the user 1 and the foreigner 2. The default arrangement therefore is that the microphone 90 is the only one that should be active initially. After the user 1 issues a command such as “over” then the arrangement reverses and the microphone 90 goes dead and the external microphone 55 goes live. One way of achieving the abovementioned arrangement is through a firmware or software program. However, in situations where full realtime two-way translation is desired, an alternative method such as using separate frequencies, telephone lines, or channels for the two translation processes can be implemented. For example, the translator 40/80 may use channel 1 for translating the speech of the user 1 and channel 2 for translating the speech of the foreigner 2. This means that while the user 1 is speaking and thereby having said speech getting translated, the foreigner 2 can also be speaking and having his speech getting translated simultaneously.

In the translating mode, the user 1 speaks into the microphone 90, his speech is thereupon translated by the translator (step 304). The user 1 may use or say the word “over” (or something similar) to command the translator that he now wants his sentence to be translated. This can also allow the translator to disable the microphone 90 and enable the external microphone 55.

A short while thereafter, the translator produces and amplifies the translated speech (step 305).

The final step of the translation process further includes the amplified translated speech signal being fed to an external loudspeaker 56 positioned on the exterior of the mouthpiece 10a producing an audible output for a foreigner 2 to hear the translation (step 306).

In the listening mode, the foreigner 2 speaks in the general direction of the user or device 10a, specifically towards microphone 55 located on the exterior of the mouthpiece, whereby the speech of the foreigner 2 is captured and thereupon gets translated by the language translator (step 307).

A short while thereafter, although at times almost instantaneously, the language translator produces the translated speech and conditions said translation signal (step 308).

As a final step in the listening mode, the processed or conditioned translated speech signal is outputted to an earphone 244 thereby allowing the user 1 to hear the translated speech of the foreigner 2 (step 309). The user 1 may then use or say the word “understand” (or something similar) to inform the translator that he's clear about what the foreigner was conveying and thus wants the circuitry of the translator to disable the external microphone 55 and enable the microphone 90.

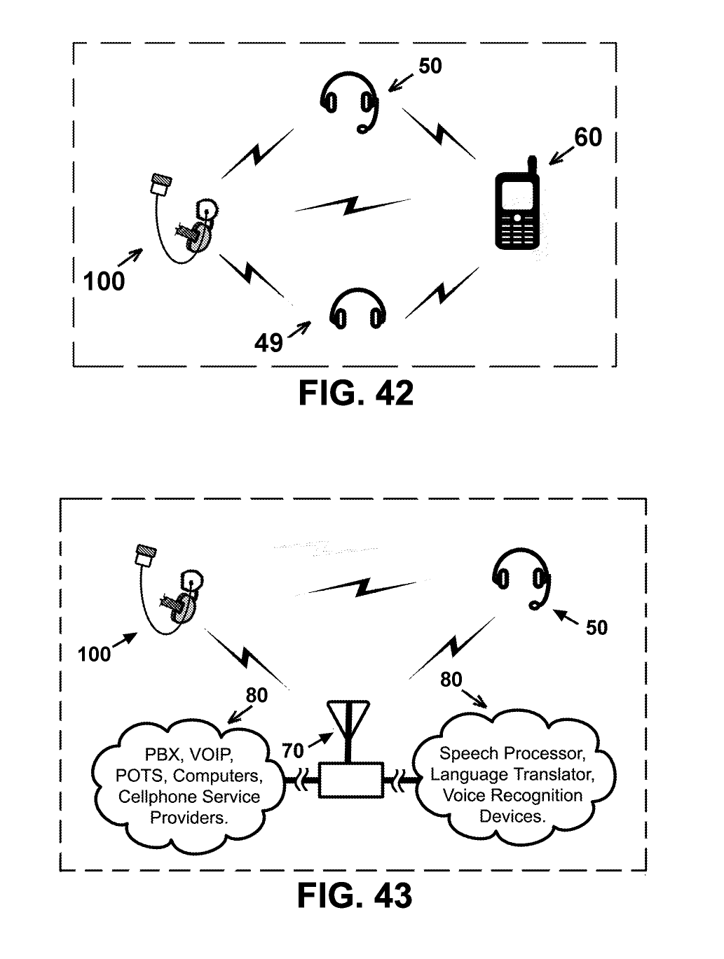

FIG. 42 shows a diagram of a helmet 100 embodiment of the invention 10 whereby the integrated transceiver is telecommunicating with either a mobile phone 60 or with a wireless headset 50 or with a cordless earphone 49 or a combination thereof. The device 100 also sends and/or receives other wireless signals such as control, monitoring, and/or management data from a mobile phone 60 or a headset 50 or a combination thereof. The mobile phone 60 generally connects to a cellphone service provider such as Verizon or AT&T which can provide translation services, and other vendors such as Interpreters Unlimited which provide telephone interpretation services. A user of invention 1 may also telecommunicate with a device having the functionalities of a wireless headset 50 or another compatible device 100.

FIG. 43 shows a diagram of a helmet 100 embodiment of the invention 10 telecommunicating with a wireless headset 50 or a wireless base station unit 70 or a RF transceiver station 70 that connects to a system 80 that further connects to subsystems such as a PC, a computer file server, a video processing system, a voice recognition system, a cellphone service provider, an automatic language translation system, a human interpreter, a telephone interpreter service, a machine translator, TELCO, POTS, a transcription machine, other voice input processors and/or a combination thereof. The device 100 can also receive wireless signals such as voice commands, test signals, control signals, video signals, monitoring and management signals from other systems 80 through base station or transceiver 70 or a headset 50 or a combination thereof.

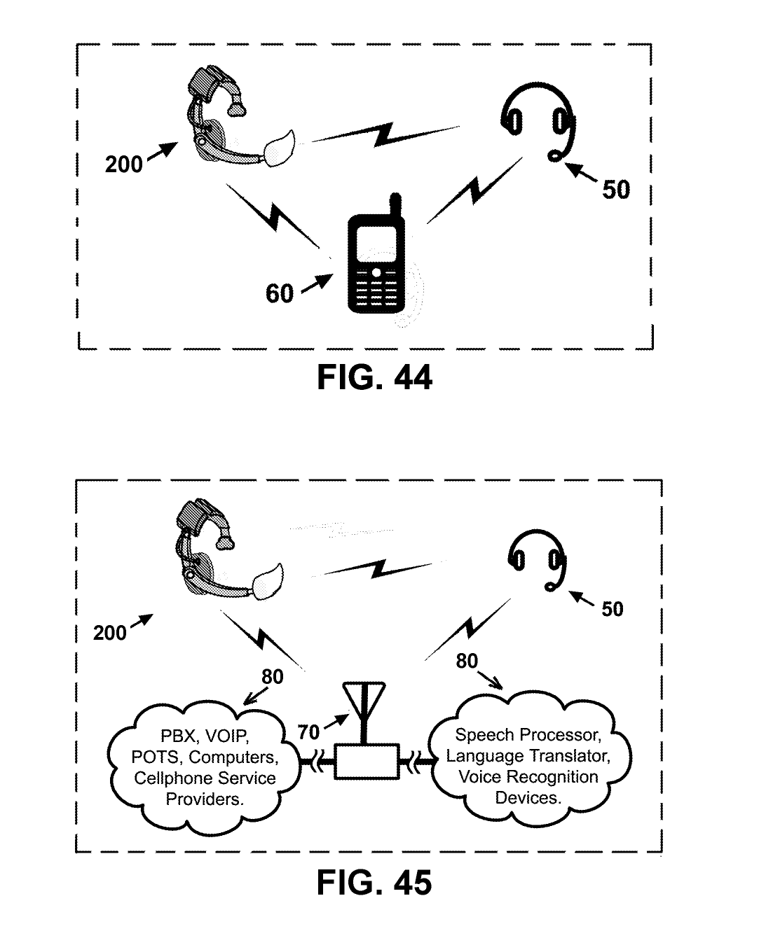

FIG. 44 shows a diagram of a headset 200 embodiment of the invention 10 whereby the integrated transceiver is telecommunicating with either a mobile phone 60 or with a wireless headset 50 or with a cordless earphone 49 or a combination thereof. The device 200 also sends and/or receives other wireless signals such as control, monitoring, and/or management data from a mobile phone 60 or a headset 50 or a combination thereof. The mobile phone 60 generally connects to a cellphone service provider such as Verizon or AT&T which can provide translation services, and other vendors such as Interpreters Unlimited which provide telephone interpretation services. A user of invention 10 may also telecommunicate with a device having the functionalities of a wireless headset 50 or another compatible device 100.

FIG. 45 shows a diagram of a headset 200 embodiment of the invention 10 telecommunicating with a wireless headset 50 or a wireless base station unit 70 or a RF transceiver station 70 that connects to a system 80 that further connects to subsystems such as a PC, a computer file server, a video processing system, a voice recognition system, a cellphone service provider, an automatic language translation system, a human interpreter, a telephone interpreter service, a machine translator, TELCO, POTS, a transcription machine, other voice input processors and/or a combination thereof. The device 200 can also receive wireless signals such as voice commands, test signals, control signals, video signals, monitoring and management signals from other systems 80 through base station or transceiver 70 or a headset 50 or a combination thereof.

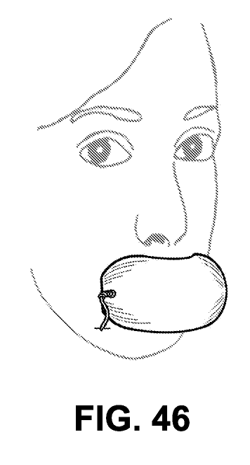

FIG. 46 shows the invention 10 in relation to a typical person who would be utilizing it. Since the invention 10 is considered a peripheral, the support structure that it can be adapted to such as a helmet or a headset is not presented herein.

I claim:

1. A compact active noise cancellation device comprising a hollow housing having a closed end and a wide-open end whereby said wide-open end is adapted to be positioned over a user's mouth area, said housing further comprising a loudspeaker that outputs a sound wave that is opposite in phase of said user's voice thereby canceling a sound wave inside said housing.

2. The compact active noise cancellation device according to claim 1 wherein said device further comprises a microphone positioned at a suitable distance from said device to capture the speech of a user.

3. The compact active noise cancellation device according to claim 1 wherein said device can be pivotally mounted onto a helmet's chin cup.

4. The compact active noise cancellation device according to claim 1 wherein said device can be pivotally attached to a headset's boom.

5. The compact active noise cancellation device according to claim 1 wherein said housing further comprises a detachable housing with noise reducing properties.

6. The compact active noise cancellation device according to claim 1 wherein said device further comprises a connector jack or plug for connecting a detachable assembly having a loudspeaker to output a user's translated speech.

7. The compact active noise cancellation device according to claim 1 wherein the electrical and electronic components of said device are associated with a sound processor positioned at a suitable distance from said housing.

8. The compact active noise cancellation device according to claim 7 wherein said sound processor further comprises an earphone to output a signal to said user.

9. The compact active noise cancellation device according to claim 2 wherein said microphone can further capture a speech of a person other than the user of said device.

10. A compact active noise cancellation device for use in a helmet arrangement comprising a hollow housing having a closed end and a wide-open end whereby said wide-open end is adapted to be positioned over a user's mouth area, said housing further comprising:
a loudspeaker;
a helmet's chin cup assembly further comprising a chin cup component and a strap arrangement;
and a support structure having one end that can be pivotally mounted onto said chin cup component and the other end fixed to said housing.

11. The compact active noise cancellation device according to claim 10 wherein said device can be detachable from said chin cup.

12. The compact active noise cancellation device according to claim 10 wherein said device further comprises a microphone located at a suitable distance from said device to capture a speech of a user.

13. The compact active noise cancellation device according to claim 10 wherein said device further comprises a connector jack or plug for connecting a detachable assembly having a loudspeaker to output a user's translated speech.

14. The compact active noise cancellation device according to claim 10 wherein said housing further comprises a detachable housing with noise reducing properties.

15. The compact active noise cancellation device according to claim 10 wherein the electrical and electronic components of said device are associated with a sound processor positioned at a suitable distance from said housing.

16. The compact active noise cancellation device according to claim 15 wherein said sound processor further comprises an earphone to output a signal to said user.

17. The compact active noise cancellation device according to claim 12 wherein said microphone can further capture a speech of a person other than the user of said device.

18. A compact active noise cancellation device for use in a headset arrangement comprising a hollow housing having a closed end and a wide-open end whereby said wide-open end is adapted to be positioned over a user's mouth area, said housing further comprising:
a loudspeaker;
a headset assembly further comprising a headband component and a boom unit;
and a support structure having one end that can be pivotally attached onto said boom and the other end fixed to said housing.

19. The compact active noise cancellation device according to claim 18 wherein said device further comprises a microphone located at a suitable distance from said device to capture a speech of a user.

20. The compact active noise cancellation device according to claim 18 wherein said device further comprises a connector jack or plug for connecting a detachable assembly having a loudspeaker to output a user's translated speech.

21. The compact active noise cancellation device according to claim 18 wherein said housing further comprises a detachable housing with noise reducing properties.

22. The compact active noise cancellation device according to claim 18 wherein the electrical and electronic components of said device are associated with a sound processor positioned at a suitable distance from said housing.

23. The compact active noise cancellation device according to claim 22 wherein said sound processor further comprises an earphone to output a signal to said user.

24. The compact active noise cancellation device according to claim 19 wherein said microphone can further capture a speech of a person other than the user of said device.
